(19) United States
(12) Patent Application Publication
(10) Pub. No.: US 2017/0351250 A1
(43) Pub. Date: Dec. 7, 2017

(54) METHOD AND APPARATUS TO REPRESENT PROCESS ALARMS IN PARENT-CHILD RELATIONSHIPS

(71) Applicant: General Electric Company, Schenectady, NY (US)

(72) Inventors: Kiran Kumar SOMAVARAPU, Hyderabad (IN); Abbik BANERJEE, Hyderabad (IN); Chirag VARSHNEY, Hyderabad (IN)

(21) Appl. No.: 15/532,732

(22) PCT Filed: Dec. 9, 2014
(86) PCT No.: PCT/US2014/069222

§ 371 Date: Jun. 2, 2017

(51) Int. Cl. G05B 23/02

(52) U.S. Cl. CPC G05B 23/0248

(57) ABSTRACT

An apparatus and corresponding methods for representing process alarms in a parent-child relationship includes an interface having an input and an output and a controller coupled to the interface. The controller is configured to access a hierarchal data structure through the interface. The data structure has at least one parent element and at least one child element, the elements representing at least one parameter in a control system. The controller is further configured to receive values of the parameter related to operation of the components at the interface and determine whether the received values indicate an alarm condition. If the received values do indicate an alarm condition, the controller is configured to access the data structure with the interface and identify an alarm element in the data structure that is associated with the alarm condition. The controller further determines, based on an examination of the alarm element, a cause of the alarm condition.

### BACKGROUND OF THE INVENTION

The subject matter disclosed herein generally relates to a computer-based control system visualization.

### BRIEF DESCRIPTION OF THE RELATED ART

Control system operators are tasked with monitoring and responding to a variety of systems and individual components in a control environment. For example, in a power plant, operators must closely monitor operating conditions of a large number of components to ensure the components remain within safe operational levels. While monitoring these control systems, troubleshooting components plays a vital role. Presently, in the event of an alarm condition, the operator generally is notified of the alarm by a computer-based device, for example a laptop or a tablet.

A variety of computer-based approaches have been used in control system environments. These alarms are displayed in a table or grid arranged chronologically, and provide little, if any, contextual information. For example, an alarm condition may occur for a “temperature sensor,” at which point the operator will be notified of this event. In these current systems, the operator is simply presented with the name of the component causing the alarm condition (e.g. “temperature sensor”), and is left to determine what component or system the alarm condition pertains to. As such, it may be difficult to correlate what alarms are being caused by particular events. This process may be time consuming and relies on the operator possessing a keen understanding of the relevant control system.

Additionally, current systems do not provide for “on the fly” modification of control system components. Currently, in the event a relationship between control system components needs to be created or later modified, the operator creates or modifies the components at a computing device containing separate programming capabilities, and then sends this information to the computer-based monitoring device. Accordingly, this task is oftentimes laborious and may lead to system inefficiencies and downtime.

The above-mentioned problems have resulted in some user dissatisfaction with previous approaches.

### BRIEF DESCRIPTION OF THE INVENTION

The approaches described herein provide systems and related methods that allow for the graphical representation of alarm conditions and their corresponding components. By using the system described herein, operators may visually identify the particular component experiencing the alarm condition, and accordingly, may alleviate or remedy the situation. Further, in the event of an alarm condition, the operator may visually identify whether any related components may potentially be affected. As such, the operator may quickly identify components which may require attention and respond accordingly.

Additionally, by selecting a particular component or parameter, historical information may be presented to the operator. Accordingly, the operator may quickly determine whether a particular component may have experienced numerous alarm conditions, and may respond accordingly. By providing for “on the fly” modification to the system, operators may reduce system downtime and corresponding costs. Thus, the approaches described herein enable cost saving techniques which additionally provide for increased system efficiencies.

In many of these embodiments, approaches are provided where values of at least one parameter related to the operation of at least one component are received. It is then determined whether the received values indicate an alarm condition. If an alarm condition is determined, a data structure is accessed which has a hierarchal structure with at least one parent and child element that represent the parameter in the control system. An alarm element in the data structure associated with the alarm condition is then identified. Based on an examination of the alarm element, a cause of the alarm condition is determined.

In some examples, the approaches further provide for forming a data structure. The method may also provide for subsequently changing the data structure by adding a parameter. Further, the method may provide for subsequently changing the data structure by deleting a parameter.

In other examples, the approaches provide rendering the data structure on a display. The element that is the cause of the alarm may subsequently be highlighted on the display. In some approaches, when the element that is the cause of the alarm is the child element, the parent element related to the child element is also displayed. Additionally, when the element that is the cause of the alarm is highlighted, the alarming condition may be acted upon by performing an action.

In further approaches, historical data is accessed to determine a past trend of the child and/or parent element. Further, in some approaches, when an alarm condition is determined an element of the data structure is displayed that may potentially be affected by the alarm condition.

In many of these embodiments, a test tool apparatus and includes an interface with an input and an output and a controller coupled to the interface. The controller is configured to access a data structure through the interface. This data structure is a hierarchal structure having at least one parent element and at least one child element, the elements representing at least one parameter in a control system. Further, the controller is configured to receive values of the parameter related to the operation of the components at the input of the interface. Upon determining an alarm condition, the controller is configured to access the data structure through the interface and identify an alarm element in the data structure that is associated with the alarm condition. The controller is also configured to determine a cause of the alarm condition.

It will be appreciated that in some approaches, the controller is further configured to subsequently change the data structure by adding or deleting an element through the output of the interface. Further, in some approaches, the controller is configured to render the data structure on a display through the interface's output. The controller may also highlight the element that is the cause of the alarm on the display.

In some examples, when the element that is the cause of the alarm is the child element, the controller displays the parent element related to the child element. When the element that is the cause of the alarm is highlighted, the controller is configured to allow the alarming condition to be acted on by performing an action.

In further approaches, the controller is configured to access historical data through the interface to determine past trends of the child element. The controller may also be configured to access historical data through the interface to determine past trends of the parent element. In yet other approaches, upon the alarm condition being determined, the controller is configured to display an element of the data structure that may potentially be affected by the alarm condition.

### BRIEF DESCRIPTION OF THE DRAWINGS

For a more complete understanding of the disclosure, reference should be made to the following detailed description and accompanying drawings wherein:

FIG. 1 comprises a block diagram illustrating an exemplary system for representing process alarms in a parent-child relationship according to various embodiments of the present invention;

FIG. 2 comprises an operational flow chart illustrating a method for representing process alarms in a parent-child relationship according to various embodiments of the present invention;

FIGS. 3A-3B comprises a block diagram illustrating a data structure representing process alarms in a parent-child relationship according to various embodiments of the present invention;

FIGS. 4A-4B comprise an operational flow chart illustrating a method for representing process alarms in a parent-child relationship according to various embodiments of the present invention;

FIG. 5 comprises a block diagram illustrating an exemplary system for representing process alarms in a parent-child relationship according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

Approaches are provided that overcome the inability to visualize components and their corresponding parameters that are signaling an alert condition. In one aspect, the systems and method collects process alarms and displays them on a user interface for an operator to take action against. During abnormal conditions, alarm troubleshooting plays a vital role in proper operation, and the visualization allows operators to examine the potentially large number of alarms generated during fault conditions. By providing for a visual representation of the system, operators may examine the relationship represented by one process variable to another process variable associated with the running process. Further, an operator may add or modify relationships based on process knowledge, and allows a person lacking substantial training to understand the state of the process.

The approaches described herein are an aspect of control configuration systems used for application code development where different variables are configured for process alarms. The approaches provide for automatically generating the graphical representation of relationships between process variables by analyzing existing variable definitions to provide graphical representations. With these graphical representations, operators may see live values of processes and their current alarm status, take action against the alarms (for example, acknowledging, shelving, unswerving, and/or resetting) both individually or as a group, modify existing relationships and/or create new relationships, merge two or more relationships, search for specific process alarm variables being used based on location, display different relationships associated with the alarm being searched for, and assist the operator in analyzing how the process is behaving.

By linking parameters of various components in a hierarchal data structure, problematic components are quickly and easily identified. For example, if a first component has a problematic first parameter value, the data structure may indicate that another second component may be the source of the problem. The identity and other information associated with this second component is thus easily presented to the user.

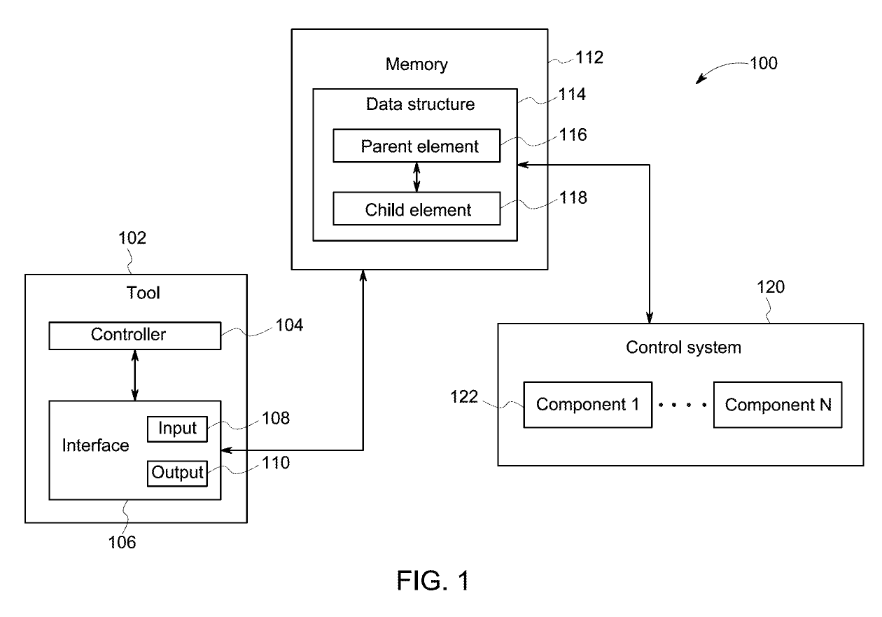

Referring now to FIG. 1, one example of a system 100 for representing process alarms in a parent-child relationship is described. The system 100 includes a tool 102 which includes a controller 104 and an interface 106 having an input 108 and an output 110, a memory 112 having a data structure 114 which includes a parent element 116 and a child element 118, and a control system 120 having any number of components 122.

The tool 102, and particularly the controller 104, is any combination of hardware devices and/or software selectively chosen to generate, display, and/or transmit communications. The interface 106 is a computer based program and/or hardware configured to accept a command at the input 108 and transmit the generated communication at the output 110. Thus, the function of the interface 106 is to allow the tool 102 to communicate with a user, the memory 112, and ultimately the control system 120.

The memory 112 may be any data storage medium capable of storing data thereto. The memory 112 may be an integral unit of the tool 102, it may be physically coupled to the tool 102 through a data connection (e.g., an Ethernet connection), or it may communicate with the tool 102 through any number of wireless communications protocols. The data structure 114 may be any type of hierarchal data file capable of storing a plurality of variables thereto. As an example, parent element 116 and child element 118 are two data entries stored in the data structure 114. It is understood that any number of parent and child elements may be used. The child element 118 represents a portion of the parent element 116. These elements represent particular parameters of the components 122 in the control system 120.

The data structures utilized herein may utilize any type of programming construct or combination of constructs stored in memory 112 such as linked lists, tables, pointers, and arrays, to mention a few examples. Other examples are possible.

The control system 120 is a combination of hardware devices and/or software selectively chosen to monitor settings of a desired system. For example, the control system 120 components 122 may include any number of components such as switches, valves, actuators, gates, pumps, sensors, gears, systems, and the like. The control system 120 may be physically coupled to the memory 112 through a data connection (e.g., an Ethernet connection), or it may communicate with the memory 112 through any number of wireless communications protocols.

It will be appreciated that the various components described herein may be implemented using a general purpose processing device executing computer instructions stored in memory.

The tool 102 communicates with the memory 112 and control system 120 through interface 106 and obtains graphic visualizations to display to an operator. The data structure 114 of memory 112 stores a variety of information pertaining to parent element 116 and child element 118, which describe characteristics and/or values of components 122 of the control system 120. The controller 104 includes an algorithm that generates relationships between elements which represent components 122.

In operation, the controller 104 accesses the data structure 114 through the interface 106. The controller 104 then receives a value of the parameter that are related to the operation of component 122 at the input 108. The controller 104 is then configured to compare the received value to predetermined “alarm” values stored in the data structure 114 which represent a parameter experiencing an alarm condition.

Upon determining that the received parameter value also represents an alarm value, the controller 104 accesses the data structure 114 through the interface 106 to identify the alarm element in the data structure 114 to which the parameter corresponds. The controller 104 then determines a cause of the alarm by examining the alarm element. In other words, the controller 104 identifies a relationship between the parameter and the child element 118, as well as any additional relationships such as what parent element 116 corresponds to the child element 118. These parameters, elements, and components may be represented in a graphical nature to assist in illustrating their purpose. For example, the component 122 may be represented by a picture of a component (e.g., a turbine) to be displayed for an operator. Accordingly, when a parameter exhibits an alarm condition, the controller is configured to identify and display a substantial amount of visual contextual information regarding the alarm condition.

In some approaches, the output 110 is coupled to a display such that the controller 104 is configured to render the data structure 114 thereon. Accordingly, an operator may examine elements of the data structure 114 and view a representation of the control system 120. In further approaches, the controller 104 is configured to highlight the element that is the cause of the alarm on the display. When the element that is the cause of the alarm is the child element 118, the controller is also configured to display the parent element 116 that is related to the child element by using the algorithm to determine any relevant relationships between elements.

As a result, when an alarm condition is present in the system 100, the operator may quickly visually identify the parameter causing the alarm condition as well as any child element 118 and parent element 116 related to the parameter. The operator may further identify any components 122 of the control system 120 that correspond to the alarm condition.

Further still, when the element that is the cause of the alarm is highlighted, the controller 104 is further configured to allow the alarming condition to be acted on by performing a suitable action. For example, upon displaying the highlighted child element 118, parent element 116, and any components 122 the alarm condition corresponds to, the controller 104, by accepting an input 108, sends a command from the output 110 to the control system 120. This command may consist of shutting down a component 122, turning on an auxiliary system, or any other known action used in control systems.

In some examples, the controller 104 is configured to change or modify the data structure 114. The controller 104 may add any number of parent elements 116 or child elements 118 through the output 110 of the interface 106. Additionally, the controller 104 may remove any number of parent elements 116 or child element 118 through the output 110 of the interface 106. The controller 104 may also create relationships between parameters and elements as well as between elements themselves.

In yet other approaches, the controller 104 is configured to access historical data saved in the data structure 114 using the interface 106. This historical data may include past trend information related to desired parameters, parent element 116, child element 118, or components 122. For example, an operator may wish to determine whether a particular component 122 has generated a significant number of alarm conditions in a given time period. The tool 102 may be used to access this information from the memory 112. It is understood that this information may be displayed at any time without the need for experiencing an alarm condition.

In still other examples, the controller 104 is configured to display an element of the data structure 114 that may potentially be affected by the alarm condition. The controller 104 analyzes related elements to the element presenting the alarm condition, and displays them to the operator. As such, the operator may allocate their time and/or resources accordingly to prevent more desirable components 122 and/or systems of the control system 120 from harm.

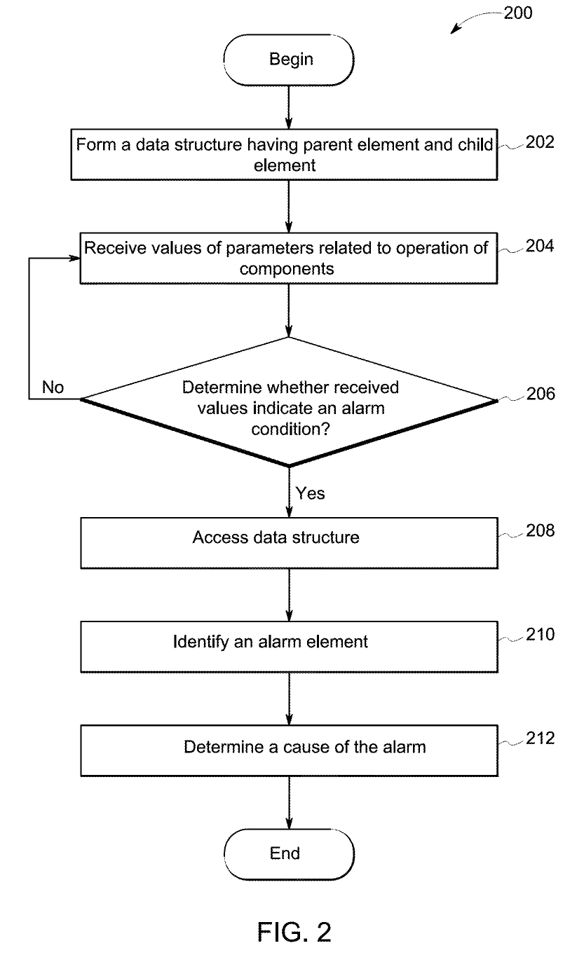

Referring now to FIG. 2, one example of a method 200 for representing process alarms in a parent-child relationship is described. First, at step 202, a data structure is formed having a parent and child element. Next, at step 204, the method 200 receives values of parameters related to the operation of components.

At step 206, the method determines whether the received values indicate an alarm condition. If the received values do indicate an alarm condition, the method proceeds to step 208, where the data structure is accessed. The data structure has a hierarchal structure with at least one parent element at and least one child element that represent the parameter in a control system. If the received values do not indicate an alarm condition, the method 200 returns to step 204, where the determination periodically continues.

Next, at step 210, the method identifies an alarm element. At step 212, a cause of the alarm is determined.

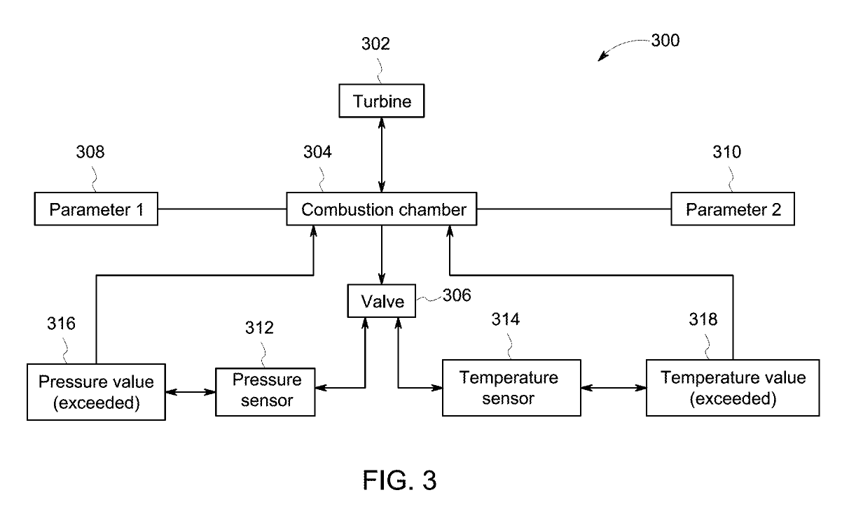

Referring now to FIG. 3, one example of a data structure 300 associated with process alarms in a parent-child relationship is described. The data structure 300 includes a first element representative of a turbine 302, a second element 304 representing a combustion chamber, and a third element 306 representing a valve. The data structure 300 further includes a first entry 312 representative of a pressure sensor and a second entry 314 representing a temperature sensor. The first entry 312 has an exceeded pressure value signal 316, and the second entry 314 has an exceeded temperature value signal 318 that are also associated with the second element 304 representing the combustion chamber. A first parameter 308 and a second parameter 310 are also associated with the second element 304.

The various elements may be themselves simply variables, arrays of values, records, or any type of structure used to organize and store data. These elements are stored in a computer memory.

In this example, the valve is a component of the combustion chamber, which is a component of the turbine. The pressure sensor and temperature sensor are coupled to the valve to monitor pressure and temperature values, respectively, of the valve. The pressure sensor and the temperature sensor also are configured to transmit signals when the pressure value 316 and the temperature value 318 have exceeded a certain threshold, respectively. The first parameter 308 and the second parameter 310 are data values that are linked to the combustion chamber 304. The parameters 308 and 310 and values 316 and 318 are arranged in a hierarchal data structure. When a problem with respect to a value or point in the data structure, pointers (or other like elements) identify other components that may also be problematic even if parameters from those elements do not indicate a problem. In other words, the values are linked to each other such that if a parameter or value is problematic, the parameter points to a component higher up in the hierarchy as a potential problem.

In one example of the usage of the data structure 300, when the turbine is functioning, the combustion chamber and the valve also perform their usual functions, and the pressure sensor and the temperature sensor periodically calculate their corresponding first entry 312 and second entry 314 and transmit the values to a controller (not shown). If the pressure value or temperature value has exceeded a certain previously determined threshold value, the system sends the exceeded pressure value signal 316 and/or the exceeded temperature value signal 318 (depending on which value has exceeded the threshold) to the controller. Because these values are linked to the combustion chamber by the data structure, the identification of the combustion chamber is also transmitted to the controller. Thus, an operator not only receives notification of a sensed value exceeding a predefined value, the operator also receives information detailing connections of the components to be able to quickly identify the larger component generating the alarm, in this case, the combustion chamber. The second element 304 representing the combustion chamber may also have other information associated with it that can be presented to the user. It will be appreciated that FIG. 3 represents one particular data structure 300 with specific relationships between components and that other examples are possible.

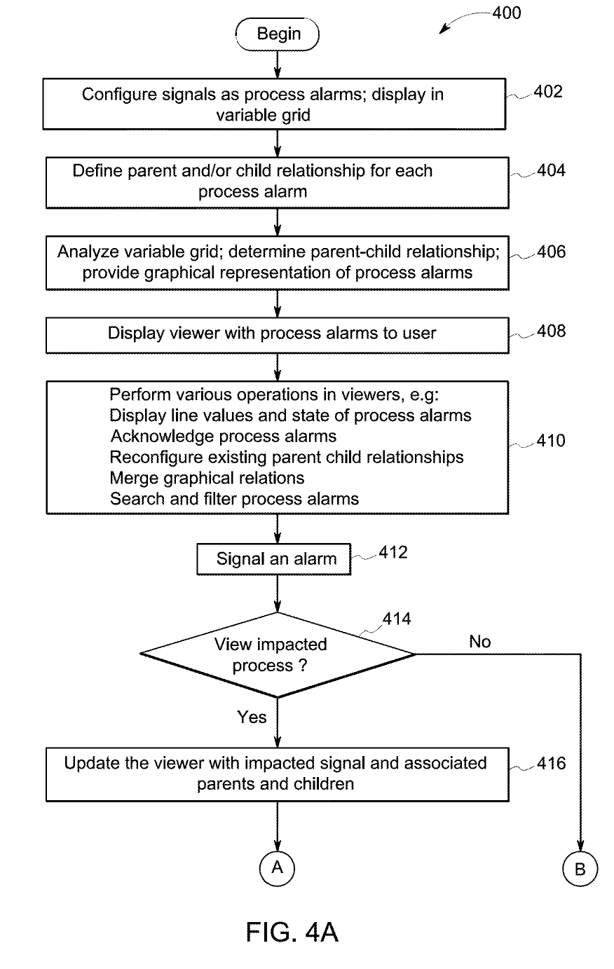

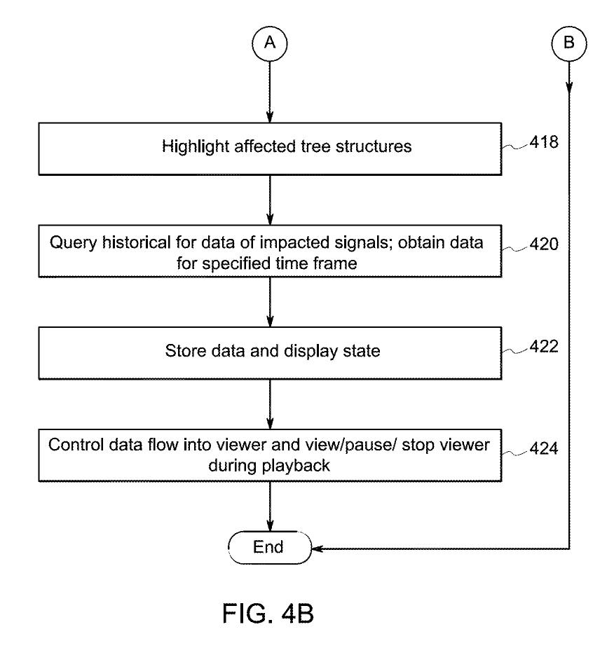

Referring now to FIGS. 4A-4B, a method 400 for representing process alarms in a parent-child relationship is provided. The method 400 begins at step 402 with configuring signals as process alarms and displaying the process alarms in a variable grid. Next, at step 404, a parent-child relationship for each process alarm is defined.

At step 406, the variable grid is analyzed to determine the parent-child relationship. A graphical representation of the process alarms which illustrate this relationship is provided. At step 408 a view is displayed with the process alarms to an operator. At step 410, various operations are performed in the viewer, such as displaying line values and the current state of the process alarms; acknowledging process alarms; reconfiguring existing parent-child relationships; merging graphical relations; and searching and filtering process alarms.

At step 412, an alarm is signaled. At step 414, the system determines whether the operator desires to view the impacted process. If the operator does not want to view the impacted process, the method 400 proceeds to end. If the operator does want to view the impacted process, the method turns to step 416, where the viewer is updated with the impacted signal and associated parents and children.

Next, at step 418, affected tree structures, or parent-child relationships, are highlighted. At step 420, historical data of the impacted signals is queried and data for a specified time frame is obtained. At step 422, this data is stored and the current state is displayed. At step 424, data flow into the viewer is controlled, and the viewer may be paused or stopped during playback.

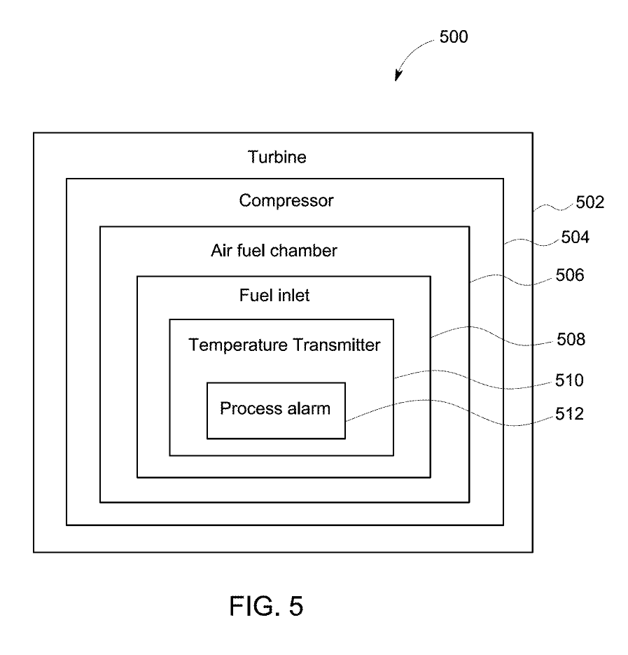

Turning to FIG. 5, a block diagram illustrating an exemplary system 500 for representing process alarms is provided. The system 500 relates to at least some of the elements provided in the data structure 300 of FIG. 3. The system 500 includes multiple components which form a turbine 502. For example, the turbine 502 includes a compressor 504, which includes an air fuel chamber 506, which in turn includes a fuel inlet 508, which includes a temperature transmitter or sensor 510, which includes a process alarm 512. These components all serve individual purposes in the exemplary system 500. It should be noted that the system 500 is merely exemplary of any number of systems containing any number of components.

In operation, the process alarm 512 corresponds to a measured temperature of the temperature transmitter 510 that has been configured for an alarm event. When the process alarm 512 is triggered, an operator is not only alerted of the process alarm, but also is alerted of the fact that the process alarm pertains to the temperature transmitter 510, which in turn is a component of or is related to the fuel inlet 508, which in turn is a component of or is related to the air fuel chamber 506, which in turn is a component of or is related to the compressor 504, which in turn is a component of or related to the turbine 502. Accordingly, the operator may quickly determine the system that requires attention in a “bottom-up” manner.

It will be appreciated by those skilled in the art that modifications to the foregoing embodiments may be made in various aspects. Other variations clearly would also work, and are within the scope and spirit of the invention. The present invention is set forth with particularity in the appended claims. It is deemed that the spirit and scope of that invention encompasses such modifications and alterations to the embodiments herein as would be apparent to one of ordinary skill in the art and familiar with the teachings of the present application.

What is claimed is:

1. A method, the method comprising:
receiving values of at least one parameter related to an operation of at least one component;
determining whether the received values indicate an alarm condition;
wherein when an alarm condition is determined:
accessing a data structure, the data structure having a hierarchal structure with a parent element and a child element, the at least one parent element and the at least one child element representing the at least one parameter in a control system;
identifying an alarm element in the data structure that is associated with the alarm condition; and
determining, based upon an examination of the alarm element, a cause of the alarm condition.

2. The method of claim 1, further comprising forming the data structure.

3. The method of claim 1, further comprising subsequently changing the data structure by adding a parameter.

4. The method of claim 1, further comprising subsequently changing the data structure by deleting a parameter.

5. The method of claim 1, further comprising rendering the data structure on a display.

6. The method of claim 5, further comprising highlighting the alarm element that is the cause of the alarm condition on the display.

7. The method of claim 6, wherein when the alarm element that is the cause of the alarm condition is the child element, displaying the parent element that is related to the child element.

8. The method of claim 7, wherein when the alarm element that is the cause of the alarm condition is highlighted, the alarm condition is acted upon by performing an action.

9. The method of claim 1, further comprising accessing historical data to determine a past trend of the child element.

10. The method of claim 1, further comprising accessing historical data to determine a past trend of the parent element.

11. The method of claim 1, wherein when an alarm condition is determined, displaying an element of the data structure that may potentially be affected by the alarm condition.

12. A test tool apparatus, the test tool apparatus comprising:
an interface with an input an and output;
a controller coupled the interface, the controller being configured to access a data structure via the interface, the data structure being a hierarchal structure with a parent element and a child element, the parent element and the child element representing at least one parameter in a control system, the controller further configured to receive values of the at least one parameter related to an operation of a component at the input of the interface and determine whether the received values indicate an alarm condition, the controller further configured to, upon determining an alarm condition, access the data structure via the interface and identify an alarm element in the data structure that is associated with the alarm condition, the controller further configured to determine, based upon an examination of the alarm element, a cause of the alarm condition.

13. The test tool apparatus of claim 12, wherein the controller is further configured to subsequently change the data structure by adding one of a parent element and a child element via the output of the interface.

14. The test tool apparatus of claim 12, wherein the controller is further configured to subsequently change the data structure by deleting one of a parent element and a child element via the output of the interface.

15. The test tool apparatus of claim 12, wherein the controller is further configured to render the data structure on a display via the output of the interface.

16. The test tool apparatus of claim 15, wherein the controller is further configured to highlight the alarm element that is the cause of the alarm condition on the display.

17. The test tool apparatus of claim 16, wherein when the alarm element that is the cause of the alarm condition is the child element, the controller is further configured to display the parent element that is related to the child element.

18. The test tool apparatus of claim 17, wherein when the alarm element that is the cause of the alarm condition is highlighted, the controller is further configured to allow the alarm condition to be acted on by performing a suitable action.

19. The test tool apparatus of claim 14 wherein the controller is further configured to access historical data via the interface to determine a past trend of the child element.

20. The test tool apparatus of claim 12, wherein the controller is further configured to access historical data via the interface to determine a past trend of the parent element.

21. The test tool apparatus of claim 12, wherein upon the alarm condition being determined, the controller is configured to display an alarm element of the data structure that may potentially be affected by the alarm condition.
